(19) United States
(12) Patent Application Publication
(10) Pub. No.: US 2011/0004481 A1
(43) Pub. Date: Jan. 6, 2011

(54) SYSTEM AND METHOD FOR COMMUNICATING AND INTERFACING BETWEEN REAL AND VIRTUAL ENVIRONMENTS

(75) Inventor: Casey Curtis Jones, Austin, TX (US)

Correspondence Address: DUBOIS, BRYANT, CAMPBELL & SCHWARTZ, LLP, 700 LAVACA STREET, SUITE 1300, AUSTIN, TX, 78701, US

(73) Assignee: Dell Products, L.P., Round Rock, TX (US)

(21) Appl. No.: 12/563,759

(22) Filed: Sep. 21, 2009

Related U.S. Application Data
(60) Provisional application No. 61/098,329, filed on Sep. 19, 2008.

(51) Int. Cl. G06Q 99/00; G06F 3/01; H04N 9/47; G06Q 30/00

(52) U.S. Cl. 705/1.1; 715/716; 348/143; 348/E09.033

(57) ABSTRACT

A human-to-avatar communication environment is disclosed in which a user comes into contact with a life-sized avatar simulating a sales assistant. The avatar communicates with the user to assist with product information, give advice, provide specifications, answer questions, and transact sales. By interacting with the user, the avatar may gather information from the user that indicates the user's interests. The avatar could assist the user by providing information that may include answering questions the user may have about certain products, directing the user to detailed information about the products, informing the user about the product that best suits the user's needs, informing the user of any complementary or popular accessories that go along with the product, helping the user purchase the products, and notifying the retail store's inventory to prepare the product for delivery or pick-up by the user. In addition, the avatar may provide the user with product information which may include information about a specific product, information about a class of products, information used in the sale of a product, a product rating, a product description, a product price, a product's features, a product's peripheral devices, or any other type of information associated with a product. The user could also be provided with information regarding promotions or prizes from an external source (e.g. online, a catalog, an advertisement, etc.) and instructions to redeem the prize at the communication environment. The avatar could then assist the user in redeeming the prize or receiving, for example, a discount offered in a promotion.

### CROSS-REFERENCE TO A RELATED APPLICATION

This non-provisional application claims priority based upon prior U.S. Provisional Patent Application Ser. No. 61/098,329 filed Sep. 19, 2008 in the name of Casey Curtis Jones, entitled “System and Method for Communicating and Interfacing Between Real and Virtual Environments,” the disclosure of which is incorporated in its entirety herein by this reference.

### BACKGROUND OF THE INVENTION

The present invention is directed, in part, to systems and methods for communications and interactions between a virtual environment and a real environment. In certain embodiments, this takes the form of communication between a virtual person or avatar and a human, such as, for example, a virtual avatar assisting a human customer through the sales and customer service processes by acquiring and providing information in real-time. For example, the avatar may be connected to a representative who is able to respond to a customer's question by providing information through the avatar. Other exemplary embodiments provide methods and systems that allow the avatar to appear in virtual settings, conduct presentations and training, offer online support and provide a variety of other services for users.

### SUMMARY OF THE INVENTION

The system and method of the present invention creates a link between the virtual world and the real world—the user in the real world communicates with the avatar in the virtual world. The avatar is controlled by a representative and becomes, in essence, a digital puppet, performing the actions requested by the representative.

In one embodiment of the present invention, a user in a human-to-avatar communication environment comes into contact with a life-sized avatar simulating a sales assistant. The avatar communicates with the user to assist with product information, give advice, provide specifications, answer questions, and transact sales. By interacting with the user, the avatar may gather information from the user that indicates the user's interests. By way of illustration, and not limitation, the avatar could assist the user by providing information that may include answering questions the user may have about certain products, directing the user to detailed information about the products, informing the user about the product that best suits the user's needs, informing the user of any complementary or popular accessories that go along with the product, helping the user purchase the products, and notifying the retail store's inventory to prepare the product for delivery or pick-up by the user. In addition, or in the alternative, the avatar may provide the user with product information which may include information about a specific product, information about a class of products, information used in the sale of a product, a product rating, a product description, a product price, a product's features, a product's peripheral devices, or any other type of information associated with a product. In yet other examples, the user could be provided with information regarding promotions or prizes from an external source (e.g. online, a catalog, an advertisement, etc.) and instructions to redeem the prize at the communication environment. The avatar could then assist the user in redeeming the prize or receiving, for example, a discount offered in a promotion.

In certain embodiments, the avatar's interaction with the user is coupled with other information provided by product manufacturers to ensure consistent product or services information and/or access to current rebates, coupons and other marketing programs from the manufacturer and/or retailer. For example, highly accurate information about products or services may be delivered on one or more screens in the human-to-avatar communication environment directly from the provider in rich video formats. The avatar may access information about a product or services from the local servers and, in those cases where the human-to-avatar communication environments are interconnected, from a data center or from other human-to-avatar communication environments. By way of example, such information may include information about a specific product or services, information about a class of products or a general type of service, information used in the sale of a product or a service, a product or service rating, a product or service description, a product price, a service fee, a product's features, a product's peripheral devices, or any other type of information associated with a product or service.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 shows three avatars A1, A2 and A3;

FIG. 2 shows a graphical representation of one embodiment of a human-to-avatar communication environment;

FIG. 3 shows several human-to-avatar communication environments connected through the Internet;

FIG. 4 shows the configuration of multiple human-to-avatar communication environments;

FIG. 5 shows a cluster of multi-use screens arranged so that each open towards the center in a cloverleaf configuration;

FIG. 6 shows a human-to-avatar communication environment in a portable configuration; and

FIGS. 7 through 10 show how other configurations are possible; the screens may be configured in an entire circle, all or part of a square, all or part of a rectangle, or may consist of a freeform shape.

### DETAILED DESCRIPTION OF THE PREFERRED EMBODIMENT

An avatar is a virtual simulation of a human form and is generally a computer-generated two- or three-dimensional representation generally of a person, animal or object. An avatar can take the appearance of anything the creator desires such as, for example, a famous person, an animated character, a mascot of a sports team, an animal, a movie character, a personified object (e.g. a talking automobile), a robot, or a graphical representation of the user. In certain embodiments of the present invention, the avatar may simulate a highly-trained retail assistant, a customer service representative, a sales clerk, or any other participant in the sales process. The name “avatar” is used herein to refer to any such character, which may be alternatively known in the art as digital assistants, virtual sales assistants, digital personas, virtual characters, or intelligent conversational agents. Also, although avatars are described herein as appearing in the avatar-to-human communication environment, it is important to recognize that the same avatars may appear online, such as in a social networking application, on a computer's desktop, or in any other environment where digital media is presented.

When an avatar takes on the appearance of a person, they will be evaluated based on their physical characteristics. People will use information derived from the virtual image in a process similar to that which they would use in the real world. However, unlike in the real world where participants in a face-to-face interaction typically don't alter their physical appearance to change the impression they make, in a virtual environment the characteristics of an avatar can be tailored to elicit any number of impressions and reactions. As a result, the overall appearance of the avatar may be dynamically linked to the user experience. An avatar that is realistic and credible can be likable and persuasive while an avatar that is pre-programmed, static, or non-engaging will lack credibility and detract from the user's experience.

Much has been written about the degree to which anthropomorphism, the attribution of human form or other human characteristics to any nonhuman object, is desirable in an avatar. In some cases, avatars that more anthropomorphic are more credible, engaging, and likeable than less anthropomorphic images but that is not always the case. In reality, responses to avatars depend on more than just their level of anthropomorphism, the context of the interaction and other characteristics of the avatar can also influence the interaction. For example, researchers have found that people had similar perceptions during interaction with either a high or a low anthropomorphic image, but ratings were lower if characteristics of avatars were inconsistent—for example, a low anthropomorphic image with very realistic behavior and vice versa. In addition, some researchers have argued that realistic avatars set up higher expectations, which may lead to disappointment when those expectations are not met. Therefore, while it appears that, in order to achieve realistic behavior it is also important to have a high anthropomorphic image, anthropomorphism is not the only predictor of how people perceive an avatar.

Credibility, attraction, and homophily are also important in the human-avatar interaction. Credibility indicates the degree to which a person is perceived as believable, trustworthy, and competent and is one of the primary predictors for certain interaction outcomes such as attitude change and trust. Homophily is the perceived degree of psychological similarity between the images and the human psyche, or the extent to which the avatar is perceived to be psychologically similar to the user. Credibility, homophily, and attraction are more abstract than anthropomorphism in determining how people are perceived but, nevertheless, people generally make judgments on these categories largely based on a person's physical characteristics. Thus, the anthropomorphism of the avatar can affect the avatar's credibility and is, therefore, of even greater importance in establishing how the avatar will influence people's decisions.

In addition to the importance of anthropomorphism, the selection of the avatar's specific physical and psychological characteristics can also be an important factor in establishing credibility in the human-avatar interaction. In work settings, researchers have found that people prefer avatars that are human (rather than, for example, an animated object or robot) and that match their own gender. This suggests that people may also prefer avatars with other characteristics that are similar to their own. For example, a user may prefer to engage with an avatar that matches their physical characteristics, such as race, hair color and eye color, as well as their more abstract interpersonal and psychological characteristics, such as extroversion, dominance, or charisma. However, the use of highly feminine avatars in video games where the majority of players are men suggests that the choice in social or gaming settings may not be as isomorphic.

Creating a highly anthropomorphic avatar requires attention to both the physical appearance of the avatar and the movement of the avatar around the virtual space. Once the physical characteristics of the avatar are determined (e.g. hair color, eye color, height, etc.), the avatar's appearance can be created using a high quality rendering program, many of which are known in the art. The avatar's facial and other features should be as detailed and realistic as the setting and the technology allows or requires. In addition, the avatar should be able to use body gestures to convey non-verbal information to the user. This adds significantly to the richness of the user experience and the credibility of the avatar. A lifelike avatar will possess a wide variety of gesture sets which will coordinate with the speech patterns of the avatar. Ideally, the movement of the avatar's lips and the tone and movement of the avatar's facial muscles should coordinate precisely with its speech.

With respect to the movement of the avatar around the virtual space, realistic avatar movement can be achieved through high quality computer animation, through the use of motion capture, or through a combination or variant of these, such as an avatar represented by a series of video and/or audio clips captured from a motion capture device where the dynamic selection of the clips to be played determines whether the avatar walks, shrugs, sits, etc. The avatar's movement in the video or animation may be asymmetrical, disjointed and somewhat random, shadowing may be used, and different parts or aspects of the body may move separately from others so as to make the avatar appear more realistic or lifelike.

Human motion capture produces characters with rich detail in their motion and, because the motion is dynamically simulated, that motion is also physically correct. In addition, motion capture provides the avatar with the ability to respond interactively to changes in the environment or in response to the user. This is important in a human-to-avatar communication environment because subtle details in the motion and timing of an animated, humanlike character can affect the credibility, aesthetic appearance, and overall impact of the character. The motion capture device may be an inertial system utilizing miniature inertial sensors, biomechanical models, and sensor fusion algorithms to capture the actor's motion; it may be a mechanical or exo-skeleton motion capture system with sensors that are attached to the body to directly track body joint angles; or it may be any other motion capture system known in the art. The actor connected to the motion capture device may be located in proximity to the human-to-avatar communication environment or at a geographically remote location.

In another embodiment, the avatar is controlled by a representative who can hear and see the user through a local or remote connection, such as through a browser on a computer, and who controls the avatar's movements through the use of a joystick, keyboard, or other device or combination of devices. This arrangement may be desirable when great detail is not required in the avatar's features or movements, such as when the avatar appears on a smaller, low-resolution monitor.

In yet another embodiment, pre-recorded animation, or a series of motion capture images, could be stored and replayed as scripts to represent the avatar. To be effective, however, the avatar must be dynamically controlled or it will not be able to effectively interact with the user. For example, as the avatar interacts with a user, the frames are played in a sequence which may be dictated by the representative. If the representative wants the avatar to walk across the screen, the representative may give a command, such as through a joystick or other controller, which invokes a sequence of motion capture images or pre-recorded animation clips to play in a sequence that simulates the desired action. In another embodiment, a representative may aggregate a plurality of movements to be executed as a macro command so that, by invoking the macro, the avatar performs one or more complex actions. In yet another embodiment, the system may add or intersperse random or non-linear movement of all or portions of the avatar's body so as to make the avatar's movement more realistic and lifelike.

In those embodiments in which the avatar is controlled through a motion capture device attached to an actor, it is possible to convey rich detail in the motion and dynamic simulation. The avatar's movement approximates a physically correct motion for the avatar, giving it the appearance of responding interactively in a virtual environment. Because the actor is able to see and hear the user through the cameras and microphones in the human-to-avatar communication environment, the avatar can move its mouth while talking, track the user's motion with its eyes, and adopt posture and gestures that are relevant to the conversation. For the reasons discussed above, these subtle details in the motion of the avatar affect the credibility, aesthetic and impact of a virtual figure in the real world.

There are a number of benefits that result from the use of an avatar that is electronically created and, therefore, relatively easily modifiable. For example, the avatar's mannerisms and appearance can be automatically altered to fit the local customs and its speech can be adapted to fit the local dialect. This may also be useful as trends changes and new styles come into vogue, an avatar can be easily updated to incorporate the latest trends.

Other benefits of using an avatar in a human-to-avatar environment include the ability to provide information in a variety of formats and styles because the avatars are controlled by more than one representative. For example, a user may prefer to speak to the avatar in a language other than English. In that case, a representative able to speak the language chosen by the user would be connected to the avatar. Alternatively, a user may be better able to understand information presented graphically in which case the avatar could show photos or videos rather than attempting long verbal explanations. Also, the avatar may be configured to recognize the speech of certain users or may be configured to communicate with disabled users such as, for example, by communicating through special devices for the hearing impaired.

Another benefit is the ability to log all interaction between the avatar and the user into a centralized database. This allows the user to initiate a conversation or a transaction with one avatar and, if they prefer, to continue working with that avatar in a subsequent session rather than starting over with a new one. It is also possible to provide a similar or substitute avatar if desired by the user.

In some circumstances, a user may prefer to pre-screen an avatar before meeting it in the human-to-avatar communication environment. In those cases, the user may access, for example, a designated website to meet an avatar prior to going into the human-to-avatar communication environment. This may be useful in allowing the user to confirm that the avatar has the appropriate expertise or simply to provide comfort to a user who has not previously interacted with an avatar. The preferences could be stored in a user profile so that one or more representatives would have access to the preferences for each specific user.

As discussed above, a user may also be predisposed to work with one type of avatar in lieu of another. For example, a user may prefer to work with a male avatar, a female avatar, a young avatar or an older avatar. Once such a predisposition is known, it is possible to provide the user with the avatar they desire and to manage the avatar workforce to accommodate the specific preferences of the user. In some instances, a prior user of an avatar may recommend the avatar to a friend, family member or acquaintance. Once the recommendation has been made known, it is possible to provide the party who has been recommended with the avatar they desire and to manage the avatar workforce to use the same preferences for the party who has been recommended as for the prior user.

Certain avatars may be more desirable in certain geographic areas because of the appearance of the avatar or the manor adopted by the representatives operating the avatar. An additional benefit of the present invention is the ability to track the avatar's performance and make decisions accordingly. For example, each avatar's sales revenue or time spent with users could be monitored to rank the avatar's relative performance among other avatars. In another embodiment, a rating system may be implemented to identify the over- and under-performing avatars. The ratings could be based, for example, on user surveys or they could be based on the aggregated sales statistics for each avatar.

The representative controls the avatar's movements and provides the “voice” to the avatar. Representatives may be highly trained, competent sales or technical representatives of the company that owns the avatar. By communicating with users through the avatar, these representatives can educate a customer to make a better informed purchase decision that will drive satisfaction with the product purchased and reinforce loyalty to retail establishments. In the retail environment, the use of representatives in communication with avatars provides advantages to both the customers and the company by ensuring adequate, but efficient, staffing that is vital to retail sales effectiveness. As such, a company can employ advanced workforce management techniques to ensure proper staffing of critical support functions to match the actual customer-traffic patterns inside each retail store location. In addition, because the staffing of the representatives in any local environment can be handled remotely, a plurality of representatives could be located at a centralized location so that representatives could be available to the local environment on demand, which provides for “cloud communicating,” conceptually similar to cloud computing, wherein the workforce is located remotely but available locally.

In one embodiment, when a user speaks to the avatar, a connection is made with a representative who is communicatively connected, such as through a computer interface, to the video and audio feeds from the avatar-to-human communication environment. Depending on the product or services with which the user wants help, the connection is established between the avatar and one or more predetermined or selected representatives. The representative may be located in or geographically near the avatar-to-human environment or in a geographically remote location. The representative may be selected based on his or her expertise or designated work responsibility. By way of example, if the user is interested in customer service, the representative could be a member of the customer service group and if the user has questions about purchasing a specific product, the representative would have experience with the product in question. When a representative receives the user's request on the representative's computer, the representative can begin a session and initiate communication with the user through the avatar.

In some embodiments, a single avatar may be supported by a wide variety of representatives with all of the information from each of the representatives consolidated in a central repository. As a result, there is an enormous degree of flexibility for each of the representatives. One representative may prefer to work a standard shift and another may prefer to work during several short periods throughout the day. Because it is not necessary for the employees to be at any specific location, only that they have computer access, it is cost effective and efficient to all employees to have flexible work hours. This provides the ability to group representatives by one or more characteristics in order to populate certain types of avatars.

In the aforementioned embodiment in which a single avatar is supported by a wide variety of representatives, it may be desirable to identify the user prior to initiating the session with the avatar so that the appropriate representative can be notified, such as through a pager, SMS text message, phone call, computer prompt or other notification method. Alternatively, the user could schedule a time through the avatar or through an electronic scheduling system so that they can verify that the desired representative is available at the desired time.

In addition, effective use of representatives is enhanced by embodiments of the invention that associate the nature of the user's inquiry with the most effective human resource available. The company can also use historical volumes of specific types of requests (e.g. certain product specialists) to model and predict future staffing needs. Historical information may be used to generate future staffing models that allow staffing according to anticipated needs. Embodiments of the present invention help predict the need for staffing and create work schedules for the representatives that match the expected needs.

In some embodiments, representatives who provide information to the avatar may be connected to the human-to-avatar communication environment through a computer interface. Statistics regarding each representative's interaction with users through the avatar can be monitored and recorded. In order to incentivize the representatives to perform more efficiently and effectively, certain of the statistics may be used in part of a game or incentive program to motivate the representatives. This could be similar in some respect to a massive multi-player online role playing game in which the representatives could compete in contests, earn points or other benefits, be awarded medallions, badges or other indicia to indicate their prowess or rank, and have the ability to purchase or acquire virtual or real assets based on their performance.

A user may be any person who interacts with either the avatar or the avatar-to-human communication environment, regardless of whether the user is a customer who purchases a product or service. The user may be a representative of a business or acting on his own behalf and may be seeking product information, software, customer support, warranty information, product recall information, or any other information on a product or service e offered by the company. The user's interaction may be initiated at the avatar-to-human environment, may be initiated online, or may be initiated through a retail kiosk located in or near the avatar-to-human communication environment.

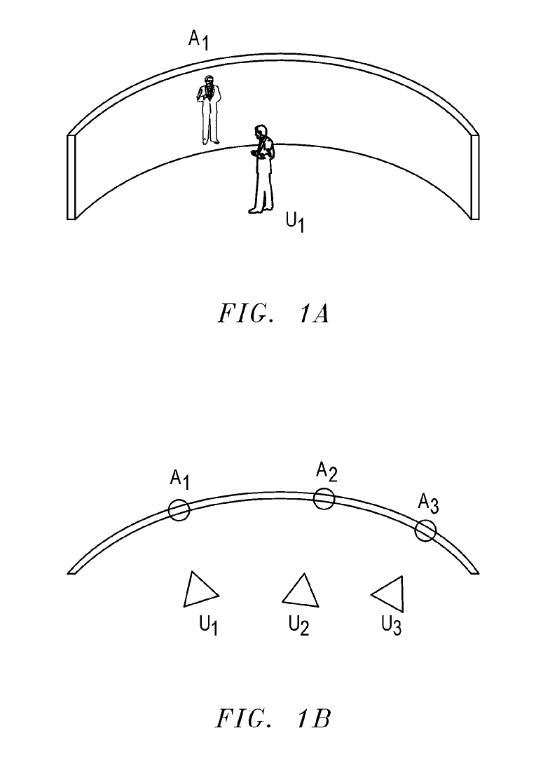

One of the complexities associated with the present invention is the mapping of avatar-to-human interaction in virtual-to-real environment. As previously discussed, it is important for the avatar to know the physical location of the user at all times so that the avatar's eyes and speech can be directed towards the user. Referring to FIG. 1, three avatars A1, A2 and A3 appear on a screen simultaneously. Each avatar has engaged with users U1, U2 and U3 respectively. Each avatar must know the location of the user with whom it is connected. For example, avatar A1 must know the location of user U1 so that (1) avatar A1's eyes can track user U1's position in a lifelike manner, (2) user U1's voice and video can be picked up by the appropriate microphone or video camera, and (3) the proper speaker can be deployed if, for example, avatar A1 is communicating with user U1 through a directional speaker.

In addition, each avatar must know the location of the other avatars so that they do not interfere with each other's communications. For example, referring again to FIG. 1, if avatar A1 is engaged with user U2 and avatar A2 is engaged with user U1, the communications between each of the avatar/user pairs would be crossed which would maximize interference and detract from the user's experience.

Similarly, each avatar must know where each avatar is located to avoid avatar-to-avatar conflict. For example, if avatar A1, avatar A2 and avatar A3 all happen to be located in the same location, or in close enough proximity that portions of their bodies are overlapping, the effect will not appear real and, once again, will diminish the credibility of each avatar and user's experience.

Just as importantly, each avatar must know where each other avatar is located to manage avatar-to-avatar relationships. For example, avatar A1 may have expertise in certain computer hardware and avatar A2 may have expertise in certain computer software applications. If avatar A1 is engaged with user U1 and user U1 asks about a software application, avatar A1 could approach avatar A2 to portray to user U1 that avatar A1 is getting information from avatar A2 or passing the user to avatar A2. In another example, avatar A1 may be a sales agent and avatar A3 may have checkout or customer service responsibilities. If a user approaches avatar A1 looking for customer service assistance, avatar A1 may want to look or gesture in the direction of avatar A3 so that the user knows which direction to proceed.

In many cases it will be desirable to prioritize the relationships between avatars and users. For example, if avatar A3 is speaking with user U3 and avatar A1 requires assistance from avatar A3, a priority rule could be established whereby avatar A3 would be required to wait to communicate to avatar A3 until avatar A3 has completed its engagement with user U1.

Finally, it is important to manage any conflicts that may arise between the users, the avatars and the environment. In one embodiment, an interactive 3d computing environment could be used to model the locations of the avatars and users as well as other physical objects in the location. The representatives would be able to navigate and deal with conflict resolution in this environment. One example is a 3d gaming engine. The environment would receive location information about the users and include a correlating depiction of the user. The detail surrounding the other objects in the environment (other avatars, users, etc.) could be scaled up or down depending on the available bandwidth.

While the present invention is useful in a retail environment, there are a wide variety of other suitable applications. For example, a multimedia display with one or more avatars could be configured as an interactive billboard. Passers-by who encounter the billboard could talk to the avatars and obtain information from them. Because the representatives who are providing information to the avatars are located remotely and are sharing responsibility for the avatar, they do not need to endure long work shifts, hot or cold temperatures, and other such difficulties which would be inevitable if the billboard was staffed in person.

In addition to the foregoing, the method and system of the present invention provides an exceptionally easy and straightforward way for business partners to engage directly with users, thereby improving the user's experience. For example, information or a link could be posted on a website or within a program connecting a company with its business partners. The information could instruct the partners how to make content available to the avatar and, after the content has been screened, it could be made available directly to the avatar for use in its presentations.

The present invention also creates an exceptionally simple method for transferring content to a user's mobile entertainment device. For example, if a user's device is capable of accessing a Wi-Fi network located in a retail establishment, the avatar could push content requested by the user to the user's device over a local area network.

Users may also appreciate the ability to interact with an avatar in online environments. Social network applications focus on building online communities of people who share interests and activities, or who are interested in exploring the interests and activities of others. Most social network services are web based and provide a variety of ways for users to interact, such as e-mail and instant messaging services. Social networking has created powerful new ways to communicate and share information and such websites are being used regularly by millions of people. The main types of social networking services are those that contain directories of certain categories (such as former classmates), those that provide a means to connect with friends, and those that operate as recommender systems linked to trust.

Recommender systems form a specific type of information filtering technique that attempts to present information items (e.g. movies, music, books, news, images or web pages) that are likely of interest to the user. Typically, a recommender system compares the user's profile to some reference characteristics. These characteristics may be from the information item (the content-based approach) or the user's social environment (the collaborative filtering approach). In the present invention, an avatar could be recommended to users with compatible user profiles. For example, a relatively young, edgy avatar may be recommended to a user with a user profile indicating a college-aged student and a liberal college or university.

The human-to-avatar communication environment is generally configured with one or more display devices (e.g. projectors, etc.) capable of displaying multimedia content on a screen or screens and simultaneously displaying one or more avatars. In many cases, a life-sized or near life-sized avatar is desirable for increased realism. The environment may be configured in any manner which facilitates the exchange of information between the avatar and the user. For example, it may include a projector for projecting media content and one or more avatars on the walls or on screens, speakers for broadcasting the voice of the avatar, video cameras for capturing images of users in the human-to-avatar communication environment in real time, and microphones for capturing the voice of the user during interaction with the avatar. The screens may be configured to cover walls from floor to ceiling, may be one or more rectangular monitors, or some combination thereof.

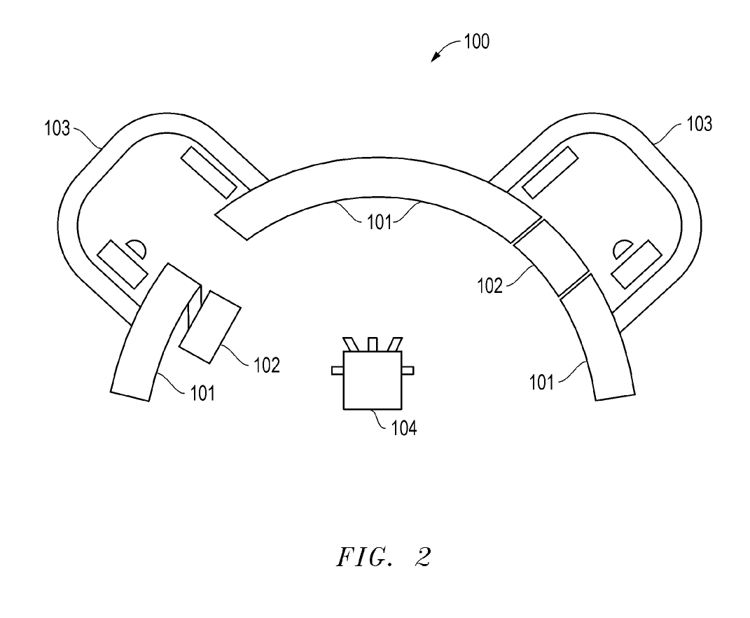

A graphical representation of one embodiment of a human-to-avatar communication environment is shown in FIG. 2. A semicircular screen 101 is configured to include one or more doors 102 which may be automatically or manually operated on command. A multi-directional projector 104 is located so as to project a continuous image on the screen 101. The projector 104 is connected to one or more servers which deliver multimedia content and the graphical representation of the avatar. Behind the doors 102 may be a small pod 103 which may be used as a secluded selling environment or other space to facilitate the sales process. One or more microphones and video cameras will be located in the human-to-avatar communication environment and those speakers and video cameras are connected to one or more servers which broadcast the feed to one or more representatives to allow them to see and hear the activity within the environment. In addition, one or more speakers are located within the human-to-avatar communication environment so that, when the representative speaks to the user, the user can hear the representative. The projector can be any front or rear projecting multimedia projector. In one embodiment, the projector is connected to one or more servers used to manage, process, display and store multimedia content. By way of example, multimedia content may include any combination of sound, photographs and movies that may be useful in creating a specific ambiance or setting and may also include information about a product, pictures of a product, video clips about the product, user reviews of the product, and information about the features of the product.

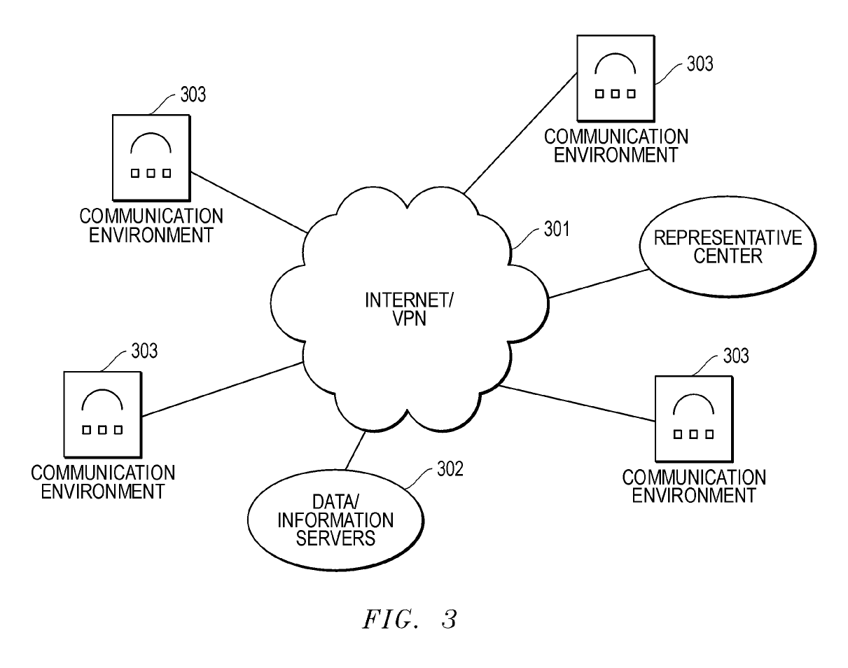

The server or servers in a human-to-avatar communication environment may operate in isolation or may be connected to one or more servers at other human-to-avatar communication environments. In addition or in the alternative, the server or servers in a human-to-avatar communication environment may be connected through the Internet, a VPN, or some other means of transmitting data to one or more data centers which manage, process, store and distribute multimedia content. FIG. 3 shows several human-to-avatar communication environments 303 connected through the Internet or a VPN 301. Each environment 303 is equipped with its own screen or screens and projector. In this embodiment, the servers driving the projectors and managing the multimedia content are located in a data center 302. The data center 302 is able to coordinate activities between the environments such as, for example, moving an avatar from one environment to another or updating product availability from a centralized location. In addition, the representatives may be located together physically or technologically in a representative center 304 and provide avatar control through the Internet 301.

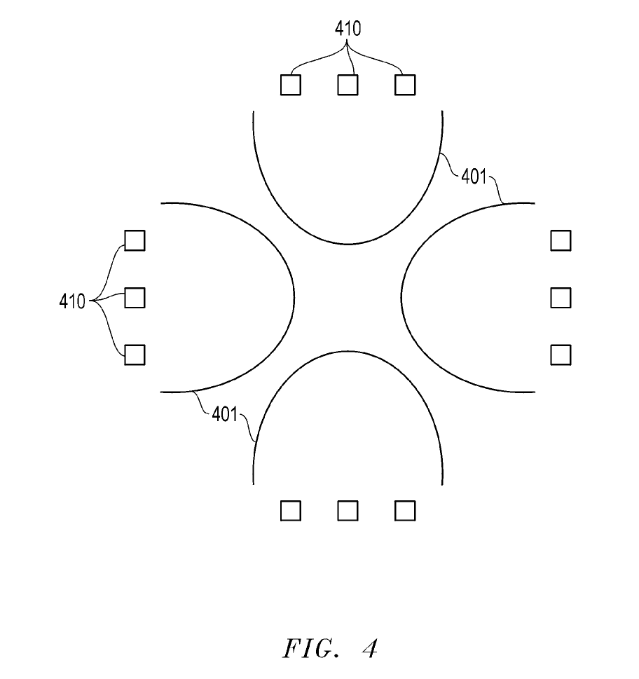

FIG. 4 shows the configuration of multiple human-to-avatar communication environments. A series of screens 401 are configured such that the surface on which the content is projected faces outward. One or more kiosks 410 may be located on the periphery. In use, an avatar appearing on a screen 401 may instruct the user to go to a kiosk 410 to acquire additional product information or to pay for a product. In one embodiment, the avatar would leave the screen 401 and appear on the designated kiosk 410 to greet the user. The user could then continue his interaction with the avatar, knowing that the avatar had the benefit of their earlier conversation.

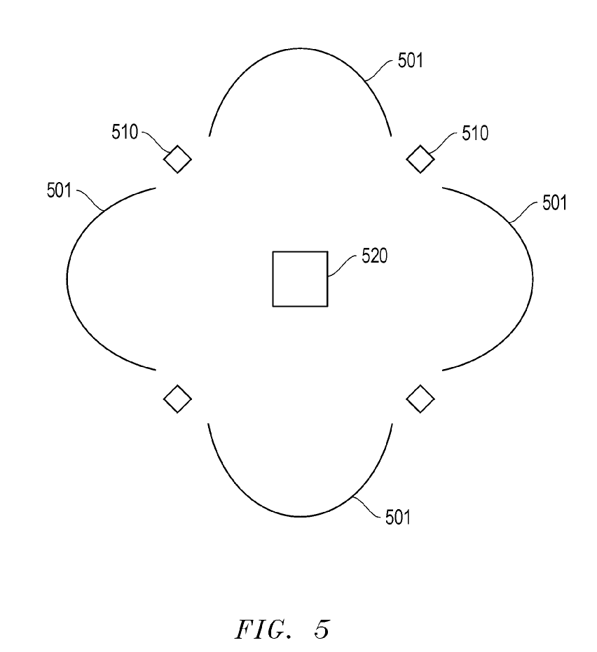

FIG. 5 shows a cluster of multi-use screens 501 arranged so that each open towards the center in a cloverleaf configuration. In this case, it may be useful to project the multimedia content from the back of the screens 501. Once again, one or more kiosks 501 may be located adjacent to the screens 501. One or more central sales stations or kiosks 520 may also be located in the center of the configuration.

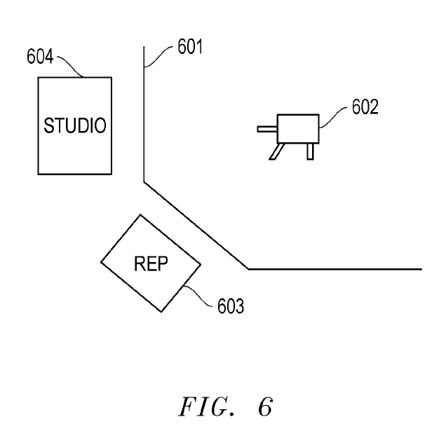

FIG. 6 shows a human-to-avatar communication environment in a portable configuration. The screens 601 may be 60 inch to 80 inch plasma screens. A relatively portable multi-directional projector 602 is located so as to project multimedia content onto the screens 601. A representative 603 is located in proximity to the screens and a studio 604 or managing the production is located near the representative 603. Microphones, speakers and video cameras would be placed in the human-to-avatar communication environment is a similar manner as the non-portable environment.

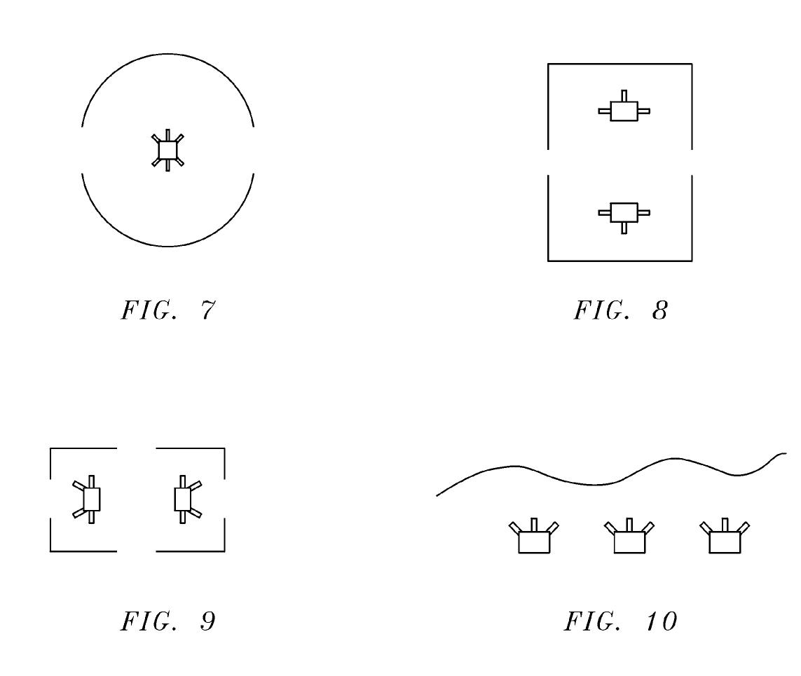

Other configurations are also possible. For example, FIGS. 7 through 10 show how the screens may be configured in an entire circle, all or part of a square, all or part of a rectangle, or may consist of a freeform shape. The resolution and details associated with the environment and the objects contained within can be scaled up or down depending on the availability of technology, bandwidth, cost and space constraints.

Because the avatar is operating in an interactive environment, it has the ability to respond to users' request for detailed product information upon request. This provides an excellent opportunity to showcase a product's features and benefits, as well as the features and benefits of its components, in response to questions raised by a user. For example, if a user is concerned about a computer's processing speed, the avatar could present graphs, charts, videos or product comparisons showing the differences between various processors. If asked about the difficulty of installing a second video card, the avatar could show a brief video demonstrating the process. In some cases, the content displayed to the user by the avatar could be provided by the component supplier. In some embodiments, the right to display content through the avatar could be sold to the component supplier's or its competitors as an alternative to traditional advertising. Additional details regarding the use of the human-to-avatar communication environment with product sales and services is provided below.

There are a wide variety of ways in which the user's experience with the avatar and the human-to-avatar communication environment can be enhanced through the use of specialty audio and visual equipment. For example, a directional speaker could be used to invite people into the human-to-avatar communication environment or to broadcast information that is relevant only to products in a specific location. A focus beam speakers could be used to target users with specific messages regarding products, services or other offerings while not disturbing other users. Once a user interacts with an avatar, a focused beam speaker could also be directed at that user and, as the user moves around the human-to-avatar communication environment, the focus beam speaker could track his motion and move with him. Other focus beam speakers used by other avatars could simultaneously be directed towards other users so they each could hear the voice of only the avatar with whom they are speaking.

In another embodiment, each user who enters a human-to-avatar communication environment could be presented with an earpiece, a headset, a personal digital assistant, or other personalized device that could be connected wirelessly to that user's avatar. This would, once again, allow a number of users to interact simultaneously with their respective avatar without interfering with other users. In yet another embodiment, a user could present a cell phone number when entering the human-to-avatar communication environment and the avatar could communicate with the user by cell phone. This alternative has the advantage of providing the company with a way to subsequently reach the user, such as by text messaging or phone calls, with information regarding, for example, product availability, product shipping status, product discounts, new product offerings, etc.

It is important to recognize that there are a wide variety of mechanisms that may be employed for communicating with the avatar. For example, one or more multi-touch displays (screens that are sensitive to more than one finger) may be employed to provide input to the avatar. Also, one or a combination of neurotransmitters, face detection, eye tracking, speech recognition and haptic technology may be used to assist in translating the user's thoughts and/or actions to the avatar.

Sending the avatar's communications directly to the user's earpiece or other wireless device is just one of a variety of ways in which a user's privacy could be maintained in a human-to-avatar communication environment. In addition, the avatar could be instructed to request human involvement if certain topics are raised by a user such as, for example, a request for specific information regarding a user's account. Alternatively, a user could be sent to a kiosk to receive or transmit sensitive information, thereby eliminating the need for it to be passed to or from the avatar.

Sending the avatar's communications directly to the user's earpiece or other personal device also provides a useful way to track the user through the human-to-avatar communication environment. This can be very useful information because an avatar's eye movement could be configured to generally track the location of the consumer. An avatar is much more realistic if its eyes track motion and this would provide the capability to do that. In addition, tracking users' locations is useful in determining how to accurately capture the user on audio or video and to know, for example, which speakers to activate when responding to the user. This could be accomplished through a variety of ways including, for example, through the use of any device with Bluetooth or RFID connection such as RFID in a USB drive the user installs in a computer, RFID in a credit card, etc. Alternatively the user could be tracked through any other method of human recognition, such as facial recognition, audio recognition, iris recognition, etc. In certain cases, it may be beneficial or desirable to associate coupons or promotions with the use of an RFID device so that customers are encouraged to use them.

In addition to tracking the motion of the user, an avatar should be aware of the location of other avatars. Unless care is taken to avoid avatar interference, all or part of two or more avatars may be projected upon one another. This will significantly impact the realistic effect of the avatar. The location, size and movement of each avatar must therefore be known to each other avatar in order to avoid avatar interference, particularly in those cases where there are a number of avatars present at one time.

In addition to providing and receiving information through a headset or other personal device, in some embodiments information is passed between the avatar and the user through the use of a touch screen such as, for example, an infrared touch screen. A touch screen is a display which can detect the presence and location of a touch within the display area, generally with a finger or hand, but sometimes with a stylus. The touch screen could be integrated into the screens in the human-to-avatar communication environment so that the avatar could direct the user to the screen and remain while the user input information. Alternatively, the touch screen could be located away from the screens so that users using touch screens did not interfere with the experience of users who were engaged with avatars.

In those embodiments where the representative is speaking directly through the avatar, it may be desirable to use a voice masking technology, many of which are already known in the art, to make the avatar's voice consistent throughout the rotation between different representatives. Alternatively, the avatar could speak using a text-to-speech application so that the avatar could speak in a similar voice regardless of which representative typed the words.

In those cases where the representative is located remotely from the avatar, it is necessary to take network latency into consideration. For example, if the representative is speaking through a remote connection and the packets carrying the representative's voice are delayed by 20 microseconds, the voice emitted from the avatar will trail the avatar's lip movement by 20 microseconds. Latency can be removed or “hidden” by prefetching (i.e. anticipating the need for data input requests) and multithreading (i.e. using parallelism across multiple execution threads). By monitoring the latency in real-time and using that information to remove the latency, the avatar's lips can be coordinated with its voice.

In those embodiments where the avatar is controlled by a representative, there may be certain rules or guidelines set by the company which govern the behavior of the avatar. These may include, for example, rules regarding the words spoken by the avatar during the first meeting with the user, restrictions on the use of slang or the use of inappropriate or offensive comments, business rules regarding the amount of time spent with any one user, etc. Because the avatar's actions can be monitored electronically and, if desired, recorded, it is possible to create a record of any actions by the avatar that may run contrary to the company's rules or guidelines.

Virtually any product could be sold through the human-to-avatar communication environment. For example, computer or electronics retailing would be an excellent fit, but the method and system of the present invention could be used in a number of retail stores where the breadth of products and their complexity make it challenging for users to make informed purchasing decisions. As an example, in the home improvement retail market, the retailers are generally large organizations with large inventories of products. It can be challenging for customers to locate products in a large retail environment and, when located, they often want instruction and information on the products they would like to purchase. Locating sales assistance can be difficult for customers and maintaining a high quality customer experience is equally challenging for retailers. The human-to-avatar communication environment of the present invention would be ideally suited for such a retailer.

The human-to-avatar communication sales environment may be sized to fit any type of location or environment where products are sold or information is provided to consumers. By way of example, a human-to-avatar communication environment may be a large company-owned “flagship” store, a smaller retail location such as in a shopping center or mall, a kiosk, an executive briefing center, a product service facility, a small space within a larger human-to-avatar communication environment, a portable facility for use at, for example, a trade show, an educational institute, a gaming center, or any other area where it may be desirable to provide a user with information about a product or service.

As can be seen from the previous examples, the human-to-avatar communication environment may be configured to fit in a variety of spaces. For example, in a relatively small configuration which could be operated with a minimal staff requirement and an exceptional virtual experience, the total size may be between 500 and 1,000 square feet with the screen area covering approximately 300 to 600 square feet. This configuration provides a high virtual area to total area ratio and could be useful in small venues with the traffic and security monitored by associates. The sale of products in this type of environment could be conducted virtually through scanning technology or other self service technologies known in the art.

In a portable configuration such as that used for commercial trade shows, product introductions or marketing events, the total size may be between 1,500 and 4,000 square feet with the screen area covering approximately 600 to 2,000 square feet. This could be a tent or other portable design used for road shows or trade venues. This could be a unique configuration for product demonstrations, introductions, and announcements and would be ideally suited for conferences and other events. For this application, the materials used in the human-to-avatar communication environment could be made of durable materials to withstand travel and the hardships of repeated installations and removals.

In a flagship location such as a destination location with a larger proportion of real inventory and staff, the total size may be between 3,500 to 7,500 square feet with the screen area covering approximately 1,500 to 3,000 square feet. This application would most likely combine a mixture of the virtual human-to-avatar communication environment and the traditional sales environment. It would be well received in a high-volume destination location where users would be drawn to the use of the avatar. The human-to-avatar communication environment could be used to showcase new applications and product offerings and would be appropriately designed and staffed with avatars to handle a high traffic environment.

The human-to-avatar communication environment may also take a purely virtual form, such as in a virtual world where visitors can participate and collaborate remotely. The avatar in this virtual retail selling environment could appear to the user in the same configuration as in the human-to-avatar communication environment. In fact, some users who are familiar with social networking applications may prefer to conduct business, gather product information, or request customer support through an avatar that is located in the virtual world.

In those cases where product is being sold by an avatar to a user, it is possible for the avatar to gather the user's preferences during the sales process that can be used to configure a product and to then integrate those preferences into a build-to-order or custom manufacturing process. This would streamline the process for the user so that they didn't have to record the avatar's recommendations and then proceed through a separate order entry process.

To further integrate the avatar into the purchase and sale process, the avatar could appear on the system purchased by the user. The avatar that appears could have the same appearance as the avatar that helped the user in the sales environment or it could have a unique appearance. In one embodiment, a user that purchased, for example, a computer from an avatar in a sales environment would see that avatar appear on the computer screen when the user started the system. Alternatively, the user may proceed through a standard start-up experience but, when problems are encountered, the avatar may appear in response to the user's request for help.

The system and method of the present invention may be used in connection with a wide variety of events, product offerings, promotions, sales etc. For example, in instances where a company is interested in introducing a new product, users could be invited to human-to-avatar communication environments across the region, country, or world at a specified date and time. The avatars could present the product simultaneously in each of the locations. Because the human-to-avatar communication environments are interconnected, users in different locations would see identical presentations. Such an introduction could create significant interest in the product through the combination of multimedia content and the presence of the avatar. For example, the avatar could be configured to resemble a well-known celebrity or an executive in the company. Each user in each location would then see that avatar presenting the product.

The avatar's interactive environment provides other opportunities as well. For example, the avatar could be instructed on one day to provide a discount to the first 10 people entering the human-to-avatar communication environment and to discontinue the program the following day. The avatar could be modified to dress in green and speak with an Irish accent to promote a St. Patrick's Day sale. The changes could be made on extremely short notice if required or could be programmed well in advance to tie in to the initiation of a traditional advertising campaign.

Because the avatar is operating in an interactive environment, it has the ability to respond to users' request for detailed product information upon request. This provides an excellent opportunity to showcase a product's components in response to questions raised by a user. For example, if a user is concerned about a computer's processing speed, the avatar could provide graphs, charts, videos or product comparisons showing the differences between various processors. If asked about the difficulty of installing a second video card, the avatar could play a brief video demonstrating the process.

In addition to making modifications to the avatar, it is also possible to customize the human-to-avatar communication environment at will. This can be useful under a number of circumstances such as, for example, when a company's partner or supplier has an existing campaign in place and wants to co-promote the campaign with the company. For example, if a new Batman movie is being released, the human-to-avatar communication environment could take the appearance of the Batcave and the avatar could take the appearance of Batman to cross-promote the event. If a new game is introduced, the human-to-avatar communication environment could take the appearance of the game setting and the avatar could appear as one of the characters. The setting would be ideal for promoting and cross-promoting products and services of valued partners.

In one embodiment, an avatar could simply act as a sales assistant in the human-to-avatar communication environment. In one embodiment, while no users are present the environment may be in a “screen saver”-type mode in which multi-media content is displayed on the screens without an avatar. A user entering the environment could trigger the activation of the avatar through a motion detector, through a noise detector, or through some other means. The activation would alert the representative to take control of the avatar and initiate communication with the user. Once activated, the avatar could offer product advice and perform demonstrations in response to the user's questions and requirements. During communication with the user, the avatar may learn what features the user desires to have in a product or specific questions regarding products or features. For example, the user may want a dual processor computer that is suitable for gaming. Based upon these requirements, the avatar may present the user with a list of products that will satisfy the user's requirements. Once a product has been selected, the avatar could guide the user through a self-checkout process and answer various questions during the process. The use of an avatar as a sales tool could be an exceptionally valuable resource, particularly with users who may be reluctant to ask sales personnel for assistance.

The human-to-avatar communication environment will include devices which will pick up audio and video feeds which will provide information to the avatar regarding the user. These feeds can be equipped with facial recognition capability to identify users in the human-to-avatar communication environment. In addition infrared cameras, ultrasonic technology or other devices may be used to track motion through the human-to-avatar communication environment. In addition, through the use of an inline analytics engine, in-store location information could be collected and used to anticipate a user's behavior or interests to provide relevant and timely product and or marketing information to the user that increases sales activity for the retailer. The invention could also proactively contact users who appear to need assistance, while operating unobtrusively for the expert shoppers.

The avatar operates in real-time which provides an opportunity to deliver content instantaneously. This is useful for updating product information, new product introductions, price changes and inventory management. For example, in those cases where the human-to-avatar communication environment is interconnected, a new product could be introduced in multiple locations simultaneously through the use of avatars. If one human-to-avatar communication environment has a location with a surplus of products, the avatar could be programmed to promote that product at a discount until the inventory reaches a desired level at which point the promotion would end.

The avatar may also instruct the user regarding the acquisition of digital content such as software, movies or other media. Once the avatar has identified the user, the avatar could offer to send content to the user via an email address on file, to beam the content to user through an infrared port, to transmit content through a port located in the human-to-avatar communication environment, or to convey the content through some other method known in the art.

Through user identification, the system can identify and recognize the retailer's best users the moment each user enters the store. The user identity may then be used to access a database of information relating to that user including, for example, the user's prior purchases, prior interaction with the retailer's web site, other interactions with customer service, etc. In addition, it is also possible to accumulate user behavior information by recording each user's movements through the store and exporting this information to a database. The traffic patterns through the store could be stored in a database and analyzed in either real time or in a in historical context. This is useful in optimizing the user experience through highly accessible product information, ties to online accounts and interaction with the retailer's loyalty and rewards programs. The user movement data can also assist the retailer in improving merchandising effectiveness and providing information to manufacturers to improve their own merchandising efforts and product mix.

Once the user becomes familiar with the avatar in the human-to-avatar communication environment, it may be desirable or advantageous to expand the experience beyond that environment. For example, once a user purchases a product in the human-to-avatar communication environment and begins setting up the product at home or in an office, the same avatar that conducted the sale could appear to direct the user through the start-up process. Similarly, if a user needs help once the system is operational, the same avatar could appear to guide the user through the troubleshooting process or direct the user to a web site where the avatar once again appears to assist the user in resolving the issue.

In addition to the selling environment, there are a number of other settings and activities that are well suited for the present invention. For example, the human-to-avatar communication environment may not be a traditional sales environment but may take the form of a business partner's solution center, a center for making presentations to business partners (either at the partner's facility or in a remote location), or a facility for the joint presentation with a business partner to a user. In these cases, multimedia content from the business partner can be integrated with the company's content to form a consolidated presentation. The avatar could be used to conduct a training session or a sales session, introduce multimedia content featuring, for example, different products at the appropriate times, and to provide both sales and technical information upon request.

In yet another embodiment, the human-to-avatar communication environment may take the form of an executive briefing center, a field sales meeting center, or a technical or certification training center. In these cases, the avatar could present the detailed information required by executives, field sales personnel, or technical employees in a manner which is both interesting and accurate. The screens in the human-to-avatar communication environment could present executives with, for example, detailed financial graphs, projections, and commentary by industry experts, all orchestrated by the avatar in a cohesive and interesting manner. Similarly, technical detail could be provided to a technical class or a certification class in a detailed but interesting manner. The avatar could control the pace of the class so that the information is provided at a comfortable pace. In addition, if students had trouble with a particular concept, the avatar could bring in additional content to provide a more detailed explanation of that concept.

In another embodiment, the human-to-avatar communication environment may be a portable environment where in the display device and one or more screens can be transported to any location. Once the display device and screens are assembled, the environment may be used in the same manner as any non-portable environment. The entire system can be self-contained if the display device is connected to a local server. However, in those cases where the display device is connected to a server with an Internet connection, multimedia content and one or more avatars can be presented from a remote location. This may be useful in cases where it is desirable to set up environments in a temporary location without incurring the time or expense of transporting one or more representatives to that location

In still yet another embodiment, the avatar may be used to conduct a video conference in lieu of a conventional video conference or geographically-separated workplace meeting. In lieu of a video camera showing the person on the phone, an avatar could be used to lead the meeting or to make presentations to the participants.

It will be appreciated by persons skilled in the art that the present invention is not limited by what has been particularly shown and described hereinabove and other embodiments may fall within the spirit and scope of the invention, as defined by the following claims.

What is claimed is:

1. A system for communicating comprising:
an avatar-to-human communication environment;
an avatar, wherein said avatar responds in real-time to visual and audio information received from a human.

2. The system of claim 1, wherein said avatar provides information relating to a sales transaction to said human.

3. The system of claim 1, wherein said avatar offers a prize promotion to said human.

4. The system of claim 1, wherein said avatar provides product warranty information to said human.

5. The system of claim 1, wherein physical characteristics of said avatar appear differently to different humans.

6. The system of claim 1, wherein said avatar appears to be a retail assistant.

7. The system of claim 1, wherein said avatar's physical characteristics are similar to those of said human.

8. The system of claim 1, wherein said avatar is controlled by a representative who can directly or indirectly see or hear said human.

9. The system of claim 1, wherein movements of said avatar are controlled by a representative in a motion capture device.

10. The system of claim 1, wherein the movements of said avatar are remotely controlled by a representative in a motion capture device and said representative's movements are transmitted across a network to said avatar.

11. The system of claim 1, wherein kiosks are located in said avatar-to-human communication environment and said avatar appears on said kiosk.

12. A system for communicating comprising:
an avatar-to-human communication environment;
an avatar visible in said avatar-to-human communication environment and communicatively connected to a representative, wherein said representative receives audio and visual information in real-time from a human located in said avatar-to-human communication environment; and
said representative responds in real-time to said human.

13. The system of claim 12, wherein said avatar provides information relating to a sales transaction to said human.

14. The system of claim 12, wherein said avatar offers a prize promotion to said human.

15. The system of claim 12, wherein said avatar provides product warranty information to said human.

16. The system of claim 12, wherein physical characteristics of said avatar appear differently to different humans.

17. The system of claim 12, wherein said avatar appears to be a retail assistant.

18. The system of claim 12, wherein said avatar's physical characteristics are similar to those of said human.

19. The system of claim 12, wherein said avatar is controlled by said representative.

20. The system of claim 12, wherein said representative controls said avatar using a motion capture device.

21. The system of claim 12, wherein the movements of said avatar are remotely controlled by said representative using a motion capture device and said representative's movements are transmitted across a network to said avatar.

22. The system of claim 12, wherein kiosks are located in said avatar-to-human communication environment and said avatar appears on said kiosk.

23. An avatar-to-human communication environment comprising:
an avatar-to-human communication environment;
an avatar displayed on a screen located in said environment;
microphones located in said environment configured to pick up the sound of a human's voice;
video cameras located in said environment configured to pick up images of said human;
speakers located in said environment; and
a representative who is communicatively connected to said environment so as to hear and see said human in real-time through said microphone and said video camera and who can respond in real time to said human visually through said avatar and aurally through said speakers.

24. The system of claim 23, wherein said avatar provides information relating to a sales transaction to said human.

25. The system of claim 23, wherein said avatar offers a prize promotion to said human.

26. The system of claim 23, wherein said avatar provides product warranty information to said human.

27. The system of claim 23, wherein physical characteristics of said avatar appear differently to different humans.

28. The system of claim 23, wherein said avatar appears to be a retail assistant.

29. The system of claim 23, wherein said avatar's physical characteristics are similar to those of said human.

30. The system of claim 23, wherein said avatar is controlled by said representative.

31. The system of claim 23, wherein said representative controls said avatar using a motion capture device.

32. The system of claim 23, wherein the movements of said avatar are remotely controlled by said representative using a motion capture device and said representative's movements are transmitted across a network to said avatar.

33. The system of claim 23, wherein kiosks are located in said avatar-to-human communication environment and said avatar appears on said kiosk.
